(19) United States
(12) Patent Application Publication
(10) Pub. No.: US 2004/0044890 A1
(43) Pub. Date: Mar. 4, 2004

(54) Apparatus and method for protecting failure of computer operating system

(76) Inventors: In-Keon Lim, Seoul (KR); In-Hyo Jeong, Yong-In City (KR)

Correspondence Address: VOLENTINE FRANCOS, P.L.L.C., Suite 150, 12200 Sunrise Valley Drive, Reston, VA, 20191, US

(21) Appl. No.: 10/650,804

(22) Filed: Aug. 29, 2003

Related U.S. Application Data
(63) Continuation of application No. PCT/KR02/00712, filed on Apr. 18, 2001.

(30) Foreign Application Priority Data
Apr. 25, 2001 (KR) 10-2001-0022334

(51) Int. Cl. G06F 9/445

(52) U.S. Cl. 713/2

(57) ABSTRACT

A method and apparatus for ensuring that the computer system does not fail to boot under any circumstances includes an invisible storage region that backs up the operating system, BIOS set-ups, and registry files for booting. The invisible storage region cannot be accessed by a user or the operating system and so is not subject to damage in the event of an abnormal shutdown due to power failure. Therefore, the computer system never fails to boot due to the damage at the hard disk containing the operating system even under the abrupt interruption of power supply.

### CROSS REFERENCES TO RELATED APPLICATIONS

This application is a continuation of International Application No. PCT/KR02/00712, filed on Apr. 18, 2001, and claims priority under 35 U.S.C. §119 from Korean Patent Application No. 2001-0022334, filed on Apr. 25, 2001, the contents of each of which are hereby incorporated herein by reference in their entirety for all purposes as if fully set forth herein.

### BACKGROUND AND SUMMARY

### Technical Field

The present invention relates to an apparatus and method for protecting a computer hard disk storing an operating system from being damaged due to an abrupt interruption of electricity supply which makes it impossible for the computer to reboot when the electricity resumes.

More particularly, the present invention relates to a computer system, such as a control computer for a digital video recorder (DVR), which has a feature that it never fails to reboot the operational system by itself when the electricity resumes after an electrical interruption.

It is desired that a security computer system, which monitors visual data transmitted from security cameras, succeed in completing a rebooting process and restore a previous condition prior to the interruption by power failure without any external help from an operator.

When the electricity feeding the computer system is abruptly interrupted, and more particularly when a power failure occurs while recording data to the hard disk, the file allocation table (FAT) that indexes the stored files is frequently damaged.

As a consequence of the damage of the FAT, it becomes impossible to reboot the system even when the electricity resumes.

As an approach to prevent the hard disk from being damaged due to the abrupt interruption of the power supply, an apparatus called an uninterruptible power supply (UPS) is widely used. An exemplary UPS is disclosed in the gazette of Korean Laid-open Patent No. 95-10276.

The technology of the UPS is based upon the preparation of a battery, that supplies the electricity for a few minutes in case of a power failure and lets the system undergo the normal shutdown process for the protection of the operating system.

FIG.1 illustrates a process of rebooting the computer system having a built-in UPS. Referring to FIG. 1, when electrical power is abruptly cut off at a point (a), the battery in the UPS starts to operate for a selected period of time, from (a) to (b), and then supplies the computer system with the electricity.

After a pre-defined period of time (for instance, one minute), the automatic shutdown process begins at step (b) in a safe manner.

Consequently, the shutdown process is terminated without damaging the hard disk at the point (c).

Now when the electricity resumes at step (d), the computer starts to reboot automatically and enters the normal operating mode at step (e) without an external operator's assistance.

Since a security system is expected to operate for twenty four hours under any circumstances, the UPS is employed in an effort to avoid damage to the computer system even in the case of the power failure.

Despite the installation of the UPS in the security system, the security system is sometimes irrevocably damaged during the power failure due to the malfunctioning of the battery.

Further to the frequent malfunctioning of the battery, it is necessary for the system manager to check the remaining lifetime of the battery and replace it from time to time in order to make sure that the security system works under all circumstances.

Furthermore, it is practically impossible for a system manager to cover the maintenance of all the UPS batteries distributed in very many places.

In addition, since the security camera is shutoff even in the case of a system having a UPS, the UPS system does not make any difference in the aspect of the continuity of the video recording.

Accordingly, it is an object of the present invention to provide an apparatus and method of preventing irrevocable damage to a computer hard disk in case of an abrupt power failure and to resolve the consequent incapability of rebooting.

It is further an object of the present invention to provide an apparatus and method for protecting the computer operating system from being damaged by an abrupt interruption of power supply so that the computer reliably operates twenty four hours a day even without a UPS.

It is another object of the present invention to provide an apparatus and method for restoring the constitution of the operating system of the security computer, the registry, and CMOS set-up in a software manner when the electricity resumes after an abrupt interruption of the power supply.

### BRIEF DESCRIPTION OF THE DRAWINGS

Further features of the present invention will become apparent from a description of a method and apparatus for protecting against the failure of computer operating system taken in conjunction with the accompanying drawings of an embodiment of the invention, which, however, should not be taken to be limitative to the invention, but are for explanation and understanding only.

In the drawings:

FIG. 1 is a timing diagram illustrating a process of rebooting a computer system having a built-in UPS;

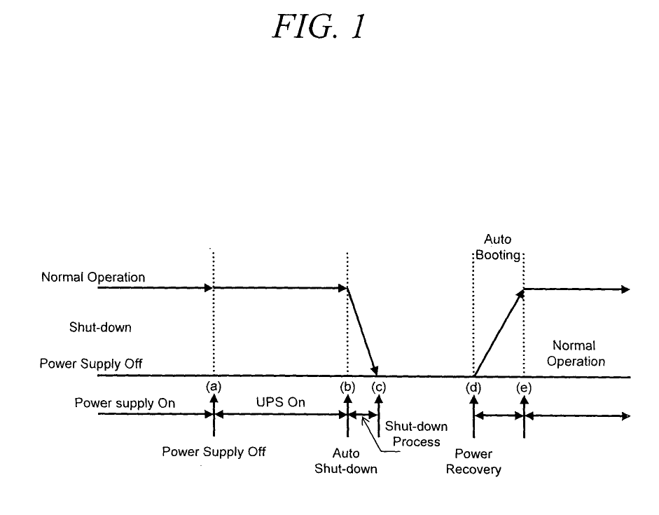

FIG.2 is a timing diagram illustrating a rebooting process that restores the previous condition software-wise without a UPS;

FIG.3 is a block diagram illustrating the constitution of a hard disk for backups, partitioned in accordance with one or more aspects of the present invention; and

FIG.4 is a flowchart illustrating a process of rebooting a computer system upon the recovery of the electricity.

### DETAILED DESCRIPTION

Features of the present invention will be explained in detail with reference to the accompanying drawings.

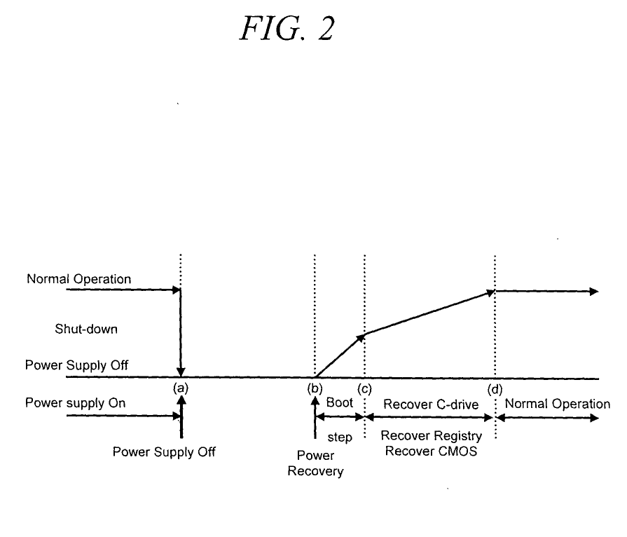

FIG.2 is a timing diagram illustrating a process of restoring a computer system. Referring to FIG.2, at step (c), i.e. the interruption of the power supply caused either by a sudden power failure or by other reasons, the protection system permits the computer system to shut down, no matter what damage may be done, and permits the computer to reboot successfully with the operating system safely stored.

As a consequence, problems such as the malfunction of the UPS battery, or its limited lifespan, are resolved.

Namely, referring to FIG.2, if the power supply is interrupted at step (a), the system shuts down without any special protection scheme such as an auto-shutdown method.

Consequently, it may happen that the hard disk may be damaged if the power failure occurs when the FAT is being written. However, the damage at the hard disk does not affect the successful rebooting process of the computer system when the electricity resumes because the damage is repaired software-wise as described below.

When the power supply is restored at step (b), as illustrated at FIG.2, the computer system is ready to start re-booting while the BIOS program normally initiates the operation.

At this time, the computer system checks the value of a first flag stored in a pre-defined location in the C-drive, and determines whether the computer system has been terminated normally or abnormally during the process of the most recent system termination. That is, a first flag indicates how the system has been terminated, i.e. either in a normal procedure of shutdown, or in an abrupt termination due to power failure. Preferably, a first flag can be stored at a pre-defined location in drive C.

If the first flag indicates an abnormal termination during the most recent shutdown process, the files for the operating system stored in an invisible storage region are copied to the disk drive C for restoration.

Here, the invisible storage region means a reserved region of a disk drive that is not accessible during a normal operation of the computer.

In other words, since the computer user has neither the recognition nor the access to the invisible storage region for writing and reading the data under the normal operation, unlike the drives C, D, and E, the invisible storage region is a safe place even during an abrupt interruption due to power failure.

The invisible storage region is also referred to herein as a first storage region, while the drives C and D are referred to as a second storage region, and the drive for storing data files is called as a third storage region.

During the restoring process, the application files, the registry files, and the BIOS CMOS set-ups are restored, as well as the system operation files.

When the system backups from the invisible storage region have been finished, the status of a first flag in drive C is reset, followed by a re-booting process under the restored operating system at drive C.

More preferably, once the operating system for the re-booting process has been restored as described herein, the damaged data at data disk D, for instance, is repaired by employing the ScanDisk function of the operating system.

Moreover, once the ScanDisk process has been completed, the registry can be normally recovered from the backups. Thereafter, a window is “popped up” on the computer display, and the status of a first flag is set.

In the detailed description above, disk drive C is designated for storing the system files, while drives D and E are designated for storing data files. However, the method of partitioning the series of hard disk need not be limited to the above-mentioned embodiment and various embodiments can be employed to implement the same principles.

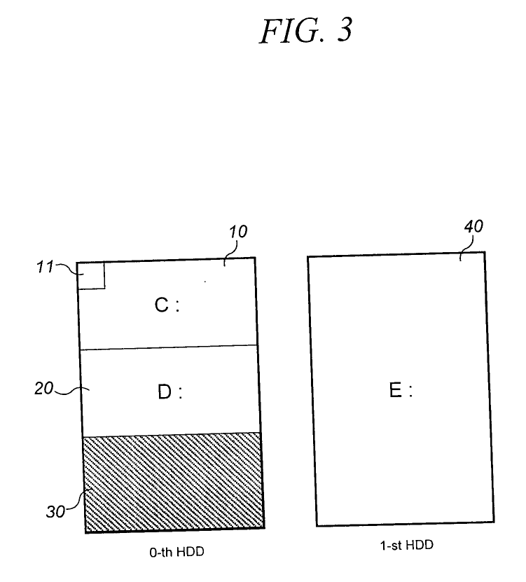

FIG. 3 is a block diagram illustrating the constitution of the partitioned hard disk in accordance with one embodiment.

Referring to FIG.3, a zero-th physical hard disk is partitioned as drive C (10), drive D (20), the invisible storage region (30), while a first physical hard disk is assigned as drive E.

Although a zero-th physical hard disk is partitioned as drive C (10), which is referred to as a first drive, and an invisible drive (30) for backups in the aforementioned embodiment, those skilled in the art should understand that a variety of embodiments are acceptable.

Beneficially, the system operating files as well as the WINDOWS® are stored in drive C (10), while the data files are stored in drive D (20) and drive E (40).

In FIG. 3 are also shown file allocation table (FAT) 11 and link files. As aforementioned, the prior art has suffered from the problem of being unable to re-boot the system since the system cannot read the link-file information from drive C due to the fat 11 being damaged by the abrupt power failure.

In an effort to resolve the above-mentioned problem, the storage region 30 is separately reserved for the backups. The invisible storage region 30 implies a storage space that is recognized for access neither by a user nor by the operating system itself. Since the invisible storage region 30 is not accessed during the normal operation of the computer, the system data stored in the invisible storage region cannot be damaged even by an abrupt interruption of electricity.

Beneficially, the system operating files, as well as the WINDOWS(g registry files, BIOS CMOS set-up files stored at drive C are backed-up in the invisible storage region for restoration during the rebooting process when the power resumes.

Beneficially, the operating system (OS) files and the application files can be back-up in the invisible storage region as a factory default when the computer system is initially assembled by the manufacturer.

More beneficially, the BIOS CMOS set-up files as well as the OS files can be backed-up in the invisible storage region 30 at the stage of the initial factory backup.

Meanwhile, the user is usually permitted to change all sorts of computer set-up parameters while the computer is used. For instance, the data compression rate or the control commands are usually set up by the user, rather than using factory defaults, for security-monitor digital video recorders (DVRs).

The set-up files such as the aforementioned data compression rates are called registry files, the updated files of which are usually saved at C:\WINDOWS\SYSTEM.DAT or C:\WINDOWS\USER.DAT under the WINDOWS® operating system.

Since the backup files saved in the invisible storage region at drive C have the factory default values, any registry files updated by a user cannot be completely restored only by the backup files stored in the invisible storage region. As a consequence, the registry files should be updated once again by the user even if the system is restored by the backup OS stored in the invisible region.

Moreover, it is not desirable to let the security computer system resume to the set-up conditions of the factory default when the electricity resumes from the power failure. In other words, the security computer system controlling the digital video recorder (DVR) should return exactly to the most recent status at an instant of power failure in order to guarantee continuous operation.

Therefore, the aforementioned problem is resolved by updating the backup files, such as like registry files, at the invisible storage region 30 from time to time.

Beneficially, every time when the set-up parameters of the registry are changed, the backup files stored at the invisible region 30 should be updated.

More beneficially, the frequency of the update of the registry files in the invisible storage region 30 can be adjusted in such a way that the updating process does not burden the workload of the central processing unit (CPU).

Beneficially, the size of the invisible storage region can be chosen as 810 MB if the capacity of the drive C is 800 MB and the file size of the registry is 5 MB.

Meanwhile, once the system restoration has been completed, the possibly damaged data files in drive D or drive E can be repaired through the ScanDisk command of the WINDOWS® program.

Moreover, when the upgraded versions of the system operating files or of the application files (for instance, the control program for monitoring the security digital video recorder) have been installed additionally, it is possible to prevent the system from returning to the factory default state during the restoration step by the method set forth below.

Since the system files that are backed-up in the invisible storage region are the ones that were initially stored at factory shipment, it is necessary to upgrade those backed-up system files in the invisible storage region if the system files have been upgraded.

Beneficially, the system operating files backed-up at the invisible storage region 30 can be upgraded by performing an additional step of updating the backup files each time that the operating system is upgraded. More beneficially, once the upgraded version of system files has been installed, backup files can be upgraded if the user consents to the upgrade.

Moreover, when new device driver files, including printer driver files, have been installed, the backup files in the invisible storage region can also be updated.

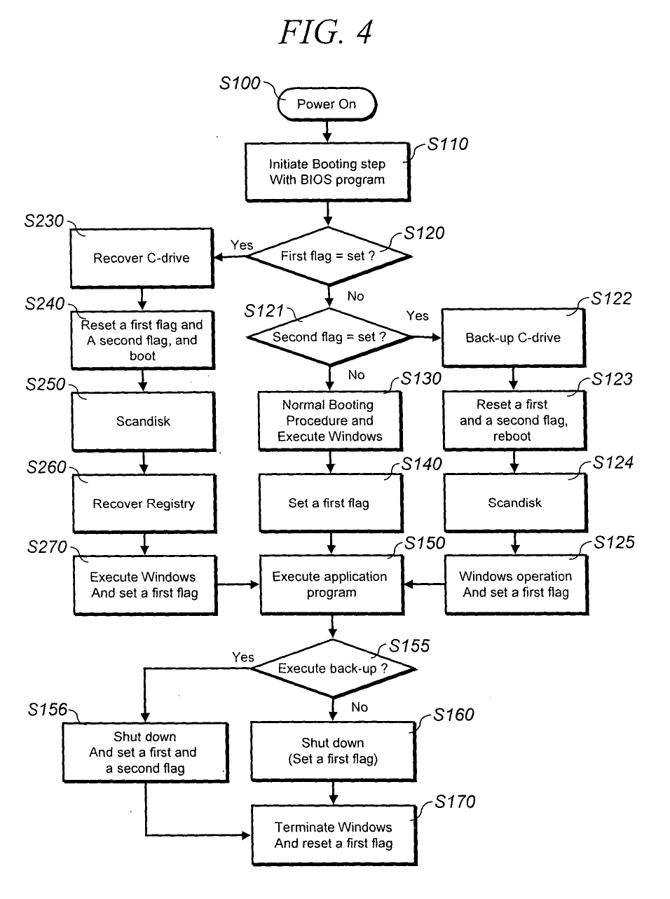

FIG.4 is a flowchart illustrating a process of re-booting a computer system.

Referring to FIG. 4, once the electricity resumes (step S100), the computer system starts to reboot, and executes the BIOS program (step S110).

Thereafter, the computer system checks the value of a first flag, which indicates whether the system has been terminated in a normal shutdown procedure or not (step S120).

Beneficially, the value of the first flag stored at a pre-defined location is set to “1” (logical one), for example, in case the system terminated abnormally during the most recent system termination, while it is reset to “0” (logical zero) in case of normal shutdown. Of course, these logical values may be reversed if so desired.

If the first flag indicates a normal shutdown during the previous termination, the system is re-booted under the normal procedure.

Beneficially, the system is implemented in such a way that a second flag can be referenced to determine whether or not an application program or device files have been upgraded. In other words, the upgraded programs and/or the information about a recently installed printer driver are backed-up in the invisible storage region, and thereby it is possible to prevent the system from returning to the state of factory default upon restoration. The second flag can be used for carrying out the above-mentioned process.

Referring to FIG. 4, the system performs the restoration process from the backup drive C (10) in the invisible storage region in the case where the second flag is set (step S121).

Meanwhile, the system follows the normal booting procedure and executes the WINDOWS® operating program (step S130) if the second flag is not set at step S121.

As a consequence, the WINDOWS® program is executed while the first flag is set in order to make sure to provide the mode of the next shutdown process (step S140). Thereafter, the application program is executed (step S150).

Beneficially, the security operating system can be executed.

More beneficially, the change in computer set-ups can update the WINDOWS® registry for a pre-defined period of time (for instance, every 30 seconds) after the setting Window is closed.

Beneficially, an upgrade of an application program or a printer driver file can make the system inquire about the user's instruction as to whether the backup files are to be updated or not (step S155).

At step S155, if the user consents with updating the backup, the process for the system shut-down is initiated, followed by setting the first flag and the second flag (step S156).

Further, if the user does not agree with updating the system backup, the computer system operating a user's application program is shutdown, followed by the process of setting the first flag in order to identify whether the system terminates normally, so that this can be determined at a time of the next booting (step S160).

Thereafter, the first flag is reset with the ending process of the WINDOWS® program (step S170).

In the meanwhile, at step S120, in the case where the flag has been set, the system recognizes that the system has been terminated abnormally and then restores the disk drive C by copying the backup files, which have been saved in the invisible storage region of the hard disk (30) (step S230).

Thereafter, once the restoration of the system has been completed, the first flag and the second flag are both reset, followed by a re-booting process (step S240).

Simultaneously, damaged data files at drives D or E can be repaired by the ScanDisk command (step S250).

Once the data files are restored (step S250), the registry is recovered (step S260) and thereafter the first flag at drive C is set (step S270) with the execution of the WINDOWS® program.

The process steps S150, S160, and S170 are followed thereafter.

Moreover, in case of manually upgrading the application program or the driver files, the backup files can also be updated by selecting a system backup menu after the program installation.

In this case, step S121 determines that the second flag is set and the system copies all of the files from the invisible storage region of the hard disk for re-booting (step S122).

Thereafter, the first flag and the second flag are both reset, followed by a re-booting process (step S123). Moreover, a ScanDisk process (step S124) is followed by the execution of the WINDOWS® program. Finally, the first flag is set (step S125) and the application program is executed (step S150).

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. A method for booting a computer system, the hard disk of which is partitioned into multiple storage regions including a first storage region being an invisible region that a user is not allowed to access and a second storage region storing an operating system, the first storage region including a backup of the second storage region, said method comprising:
(a) checking the value of a first flag that indicates whether a last termination was a normal shutdown or an abrupt interruption due to power failure when electricity resumes and a BIOS program starts to be executed;
(b) when the first flag indicates the abrupt interruption, restoring the second storage region by copying files backed-up at the first storage region, and then resetting the first flag and a second flag that indicates whether the contents stored in the second storage region are also to be manually backed-up in the first storage region, followed by performing a re-booting process;
(c) checking the second flag when the value of the first flag indicates the normal termination in step (a);
(d) when the second flag indicates a manual backup in step (c), performing a backup to the first storage region of the contents stored in the second storage region, and then resetting the first flag and a second flag, followed by performing the re-booting process;
(e) when the second flag indicates no manual backup in step (c), performing a normal booting process, executing a Windows program, and setting the first flag; and
(f) executing an application program.

2. The method as set forth in claim 1, wherein said step (b) is followed by:
performing a ScanDisk operation to restore a third storage region which stores the data files for the computer system; and
restoring the registry of the computer system and operating the WINDOWS® operating system, followed by setting the first flag.

3. The method as set forth in claim 1 wherein said step (d) further comprises:
performing a ScanDisk operation to restore a third storage region which stores the data files for the computer system; and
operating the WINDOWS® operating system, followed by setting the first flag.

4. The method as set forth in claim 1 further comprising:
(g) determining whether a user has requested a manual backup;
(h) when the manual restoration has been requested at step (g), backing-up contents of the second storage region into the first storage region when the computer operating system has been either upgraded or additionally installed, performing a system shut-down, and setting the first flag and the second flag;
(i) when the manual restoration was not requested in step (g), performing a system shut-down procedure and setting the first flag; and
(j) operating the WINDOWS® operating system, followed by resetting the first flag.

5. The method as set forth in claim 1 wherein the first storage region stores backups of: BIOS CMOS setup files or factory default files stored in the second storage region; registry files for system operation updated by the computer user while using the computer; device driver files installed additionally or upgraded files installed in the second storage region while using the computer; and a software program for performing the backup procedure.

6. A computer system, the hard disk of which is partitioned into a multiple of storage regions including an invisible first storage region that a user is not allowed access and a second storage region storing an operating system, the system comprising:
a first flag indicating whether the computer system has been shutdown normally or abnormally during a most recent termination; and
a second flag indicating whether updated program files or additionally installed device driver files stored in the second storage region should be backed-up in the first storage region,
wherein, once a BIOS program starts to be executed at an initiation step of booting:
the computer system is rebooted by backed-up operating system files stored in the first storage region, when said first flag indicates the abnormal shutdown,
backed-up files stored in the second storage region are copied to the first storage region, when said first flag indicates normal shutdown and said second flag indicates a manual backup, and
a normal booting process is performed by the operating system files stored in the second storage region when said first flag indicates a normal shutdown and said second flag does not indicate a manual backup.

7. The computer system as set forth in claim 6, wherein said first storage region stores backups of system operating files, BIOS CMOS files, and system operating registry files, while a backup process control program is stored in said first storage region that is invisible to the computer user.

8. The computer system as set forth in claim 6, wherein said hard disk further includes a third storage region for storing data files, and when said first flag indicates the abnormal shutdown during the most recent termination, said third storage region is repaired by the WINDOWS® command ScanDisk and a computer registry is restored.

9. The computer system as set forth in claim 6, wherein when the system operating files stored in said second storage region are upgraded during use of the computer, the upgraded system operating files are backed-up in said first storage region such that the computer system is booted with the upgraded system operating files.

10. The computer system as set forth in claim 6, wherein when a device driver file including a printer driver file is additionally installed during use of the computer system, the device driver file stored in said second storage region is backed-up in said invisible first storage region, and the additionally-installed driver file can be recognized during the re-booting step after the abnormal termination.

11. The computer system as set forth in claim 6, wherein said system operating registry files comprise a system data file (SYSTEM.DAT) and a user's information file (USER.DAT) under the WINDOWS® operating system.

12. A method for booting a computer system, the hard disk of which is partitioned into a multiple of storage regions wherein a first storage region is an invisible region that the user is not allowed to access, and a second storage region storing the operating system, a BIOS program, COMS set-ups, and registry files that are updated during use of the computer system, the first storage region having a backup of the second storage region, the method comprising:
(a) supplying electricity to the computer;
(b) executing the BIOS program as a booting process is initiated;
(c) checking a state of a first flag which indicates whether the last system shutdown was a normal termination or an abnormal termination due to an abrupt power failure;
(d) restoring the second storage region to a previous state prior to the last system shutdown by reading out files from the invisible first storage region and writing them into the second storage region, when the first flag indicates that the last system shutdown was an abnormal termination at step (c);
(e) resetting the first flag and a second flag that indicates a manual backup process, followed by a rebooting process;
(f) executing a WINDOWS® ScanDisk command on a third storage region storing data files;
(g) restoring a registry that has been backed-up in the invisible storage region; and
(h) executing a WINDOWS® operating program, followed by setting the first flag.

13. A method for booting a computer system, the hard disk of which is partitioned into a multiple of storage regions wherein a first storage region is an invisible region that the user is not allowed to access, and a second storage region storing the operating system, a BIOS program, COMS set-ups, and registry files that are updated during use of the computer system, the first storage region having a backup of the second storage region, the method comprising:
(a) supplying electricity to the computer;
(b) executing the BIOS program as a booting process is initiated;
(c) checking a state of a first flag which indicates whether the last system shutdown was a normal termination or an abnormal termination due to an abrupt power failure;
(d) when the first flag indicates a normal termination, checking a state of a second flag that indicates whether data stored in the second storage region are also to be manually backed-up in the first storage region;
(e) when the second flag indicates a manual backup, backing-up the contents at the second storage region into the first storage region;
(f) resetting the first flag and the second flag, followed by the re-booting process;
(g) restoring a registry that has been backed-up in the invisible storage region; and
(h) executing a WINDOWS® program, followed by setting the first flag.

14. A method for booting a computer system, the hard disk of which is partitioned into a multiple of storage regions wherein a first storage region is an invisible region that the user is not allowed to access, and a second storage region storing the operating system, a BIOS program, COMS set-ups, and registry files that are updated during use of the computer system, the first storage region having a backup of the second storage region, the method comprising:
(a) supplying electricity to the computer;
(b) executing the BIOS program as a booting process is initiated;
(c) checking a state of a first flag which indicates whether the last system shutdown was a normal termination or an abnormal termination due to an abrupt power failure;
(d) when the first flag indicates a normal termination, checking a state of a second flag that indicates whether data stored in the second storage region are also to be manually backed-up in the first storage region;
(e) executing a WINDOWS® program under a normal booting procedure when the second flag is reset; and
(f) setting the first flag.

15. The method for booting the computer system as set forth in claim 12, further comprising:
executing an application program stored in the second storage region;
backing-up the data of the second storage region into the first storage region;
shutting down the computer system and setting the first flag and the second flag; and
closing the WINDOWS® program and resetting the first flag.

16. The method for booting the computer system as set forth in claims 12, 13 or 14, wherein said method further comprises steps of:
executing an application program stored in the second storage region;
shutting the computer system down and setting the first flag and the second flag without backing-up the data of the second storage region into the first storage region; and
closing the WINDOWS® program and resetting the first flag.
